(19) United States
(12) Patent Application Publication
(10) Pub. No.: US 2022/0134809 A1
(43) Pub. Date: May 5, 2022

(54) PNEUMATIC TIRE

(71) Applicant: Toyo Tire Corporation, Itami-shi (JP)

(72) Inventor: Naoya Kubo, Itami-shi (JP)

(73) Assignee: Toyo Tire Corporation, Itami-shi (JP)

(21) Appl. No.: 17/500,237

(22) Filed: Oct. 13, 2021

(30) Foreign Application Priority Data
Oct. 29, 2020 (JP) 2020-181787

(51) Int. Cl. B60C 15/06

(52) U.S. Cl. CPC B60C 15/0628; B60C 2015/0639

(57) ABSTRACT

A pneumatic tire according to an embodiment includes: a carcass ply including organic fiber cords; and a side reinforcement layer including metal cords. The side reinforcement layer extends along a lateral surface of a bead filler, and extends beyond an outer end of the bead filler to an outer side in a tire radial direction. The carcass ply includes: a first ply stretched between bead cores; and a second ply arranged on a tire outer surface side of the first ply. An inner end portion in the tire radial direction of the second ply is superimposed on an outer end portion in the tire radial direction of the side reinforcement layer, and the second ply extends to the outer side in the tire radial direction from the inner end portion and is terminated at a position at which the second ply is superimposed on an end portion of a belt.

### CROSS-REFERENCE TO RELATED APPLICATIONS

This application is based upon and claims the benefit of priority from the prior Japanese Patent Application No. 2020-181787, filed on Oct. 29, 2020; the entire contents of which are incorporated herein by reference.

### BACKGROUND

### 1. Field of the Invention

Embodiments of the present invention relate to a pneumatic tire.

### 2. Description of Related Art

A pneumatic tire is provided with a carcass ply from a tread to a bead through a sidewall, and a belt is arranged on an outer circumference of a crown of the carcass ply. In order to reduce weight of the pneumatic tire, JP-A-2001-191722 discloses a carcass ply that includes, in the crown thereof, a missing section in a region corresponding to 30 to 60% of a belt width, that is, the carcass ply with a so-called blank structure.

Meanwhile, in JP-A-8-11234, a turn-up ply and a blank down ply are provided as the carcass ply. The turn-up ply has a folded section that is folded around a bead core from an inner side to an outer side and is provided across a pair of the bead cores. On a tire outer surface side of the turn-up ply, the blank down ply extends from a belt inner surface position in each lateral region excluding a central region of the tread to at least a bead core.

### SUMMARY

The weight of the pneumatic tire can be reduced by providing the ply with the blank structure to the carcass ply. However, further improvement has been requested in a point of reducing the weight of the pneumatic tire while maintaining rigidity thereof.

Embodiments of the present invention have a purpose of providing a pneumatic tire capable of simultaneously obtaining rigidity and weight reduction.

A pneumatic tire according to an embodiment of the present invention includes: a pair of bead cores; a carcass ply that includes organic fiber cords and is stretched between the pair of bead cores; a belt that includes metal cords and is arranged on an outer side in a tire radial direction of a crown of the carcass ply; a bead filler that is arranged on an outer side in the tire radial direction of each of the bead cores; and a side reinforcement layer that includes metal cords, is arranged along a lateral surface of the bead filler, and extends to the outer side in the tire radial direction beyond an outer end of the bead filler. The carcass ply includes: a first ply stretched between the pair of bead cores; and a second ply arranged on a tire outer surface side of the first ply. An inner end portion in the tire radial direction of the second ply is superimposed on an outer end portion in the tire radial direction of the side reinforcement layer, and the second ply extends to the outer side in the tire radial direction from the inner end portion and is terminated at a position at which the second ply is superimposed on an end portion of the belt.

The pneumatic tire according to the embodiment of the present invention can simultaneously obtain rigidity and weight reduction.

### BRIEF DESCRIPTION OF THE DRAWINGS

FIG. 1 is a cross-sectional view of a half cross section of a pneumatic tire according to a first embodiment.

FIG. 2 is a schematic view of a half cross section of the pneumatic tire according to the first embodiment.

FIG. 3 is a partial enlarged view of FIG. 1 (a cross-sectional view of an end portion of a tread).

FIG. 4 is a partial enlarged view of FIG. 1 (a cross-sectional view of a bead).

FIG. 5 is a schematic view of a half cross section of a pneumatic tire according to a second embodiment.

FIG. 6 is a partially enlarged cross-sectional view of the pneumatic tire according to the second embodiment.

FIG. 7 is a schematic view of a half cross section of a pneumatic tire according to a third embodiment.

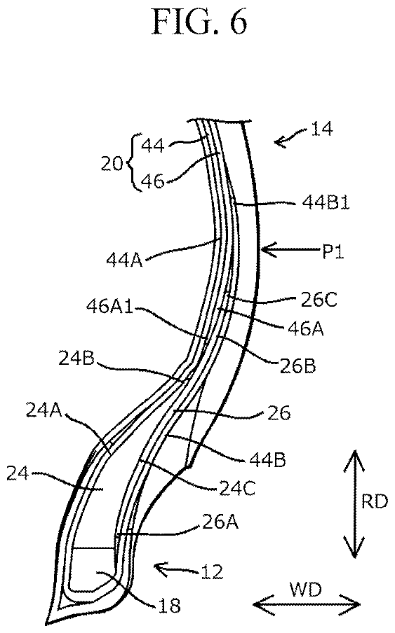

FIG. 6 is a schematic view of a half cross section of a pneumatic tire in Comparative Example 2.

### DESCRIPTION OF THE PREFERRED EMBODIMENTS

A description will hereinafter be made on embodiments of the present invention with reference to the drawings.

### First Embodiment

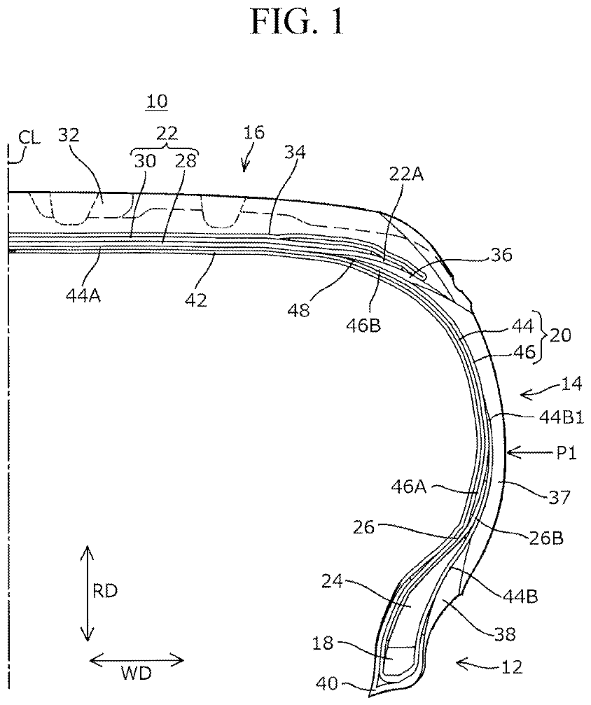

A pneumatic tire 10 (hereinafter simply referred to as a tire 10) according to a first embodiment illustrated in FIG. 1 has: a right and left pair of beads 12, each of which is fixed to a rim; a right and left pair of sidewalls 14, each of which continues to an outer side in a tire radial direction from respective one of the paired beads 12; and a tread 16 that extends between the paired sidewalls 14 and constitutes a ground contact surface. FIG. 1 is a cross-sectional view of a right half portion of the tire 10 that is cut in a meridian cross section including a tire rotation axis. In this example, the tire 10 is bilaterally symmetrical.

In the drawings, a tire equatorial plane CL corresponds to a center in a tire axial direction. In the present specification, a tire width direction means a parallel direction to the tire rotation axis and is denoted by a reference sign WD in the drawings. An inner side of the tire width direction WD is a direction toward the tire equatorial plane CL while an outer side in the tire width direction WD is a direction away from the tire equatorial plane CL. The tire radial direction means a perpendicular direction to the tire rotation axis and is denoted by a reference sign RD in the drawings. An inner side of the tire radial direction RD is a direction toward the tire rotation axis while an outer side in the tire radial direction RD is a direction away from the tire rotation axis. A tire circumferential direction is a rotational direction with the tire rotation axis being a center.

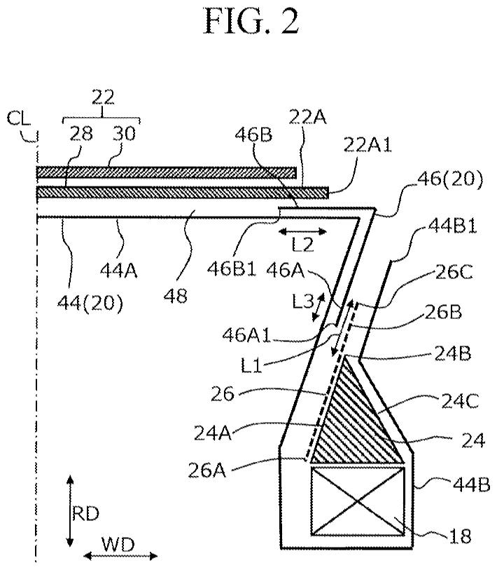

As illustrated in FIG. 1 and FIG. 2, the tire 10 includes: a pair of bead cores 18; a carcass ply 20 stretched between the paired bead cores 18; a belt 22 arranged on the outer side in the tire radial direction RD of a crown of the carcass ply 20; a bead filler 24 arranged on the outer side in the tire radial direction RD of each of the bead cores 18; and a side reinforcement layer 26 arranged along a lateral surface of the bead filler 24.

The bead core 18 is an annular member that is formed of a steel bead wire and extends for an entire circumference in the tire circumferential direction, and is embedded in the bead 12. The bead filler 24, which is installed on an outer circumference of the bead core 18, is also embedded in the bead 12. The bead filler 24 is an annular hard rubber member having a substantially triangular cross section, a width of which is narrowed toward the outer side in the tire radial direction RD, and extending for the entire circumference in the tire circumferential direction.

The carcass ply 20 is stretched in a toroidal shape between the paired bead cores 18. That is, the carcass ply 20 extends from the tread 16 to each of the paired beads 12 through the sidewall 14 on each side, and is then locked by the respective bead 12. The carcass ply 20 includes organic fiber cords as a reinforcing material. In detail, the carcass ply 20 includes an arrangement body of the organic fiber cords and topping rubber that covers the arrangement body. The arrangement body is formed by arranging specified cord count of the organic fiber cords in parallel. The organic fiber cords are disposed at a substantially right angle (for example, 80° to 90°) with respect to the tire circumferential direction, that is, along a meridian direction. Examples of the organic fiber cords are polyester fiber cords, rayon fiber cords, aramid fiber cords, and nylon fiber cords.

The belt 22 is installed on the crown, that is, on an outer circumferential side of a top portion of the carcass ply 20 in the toroidal shape. In the tread 16, the belt 22 is superimposed on an outer circumferential surface of the carcass ply 20. The belt 22 is constructed of at least one, preferably, two or more belt plies. In this example, the belt 22 is constructed of two belt plies that are: a first belt 28 as a maximum-width belt; and a second belt 30 that is superimposed on an outer circumference of the first belt 28 and has a narrower width than the first belt 28. Each of the first belt 28 and the second belt 30 includes metal cords such as steel cords. In detail, each of the first belt 28 and the second belt 30 is formed by inclining the metal cords at a specified angle (for example, 15° to 35°) with respect to the tire circumferential direction, disposing the metal cords at specified intervals in the tire width direction WD, and being covered with the topping rubber. The metal cords are disposed such that the metal cords in the belt 28 cross the metal cords in the belt 30.

Tread rubber 32 that serves as a ground contact area is provided on the outer side in the tire radial direction RD of the belt 22. In this example, a belt reinforcing layer 34 is provided between the belt 22 and the tread rubber 32. The belt reinforcing layer 34 is constructed of a cap ply having organic fiber cords that extend substantially in parallel with the tire circumferential direction.

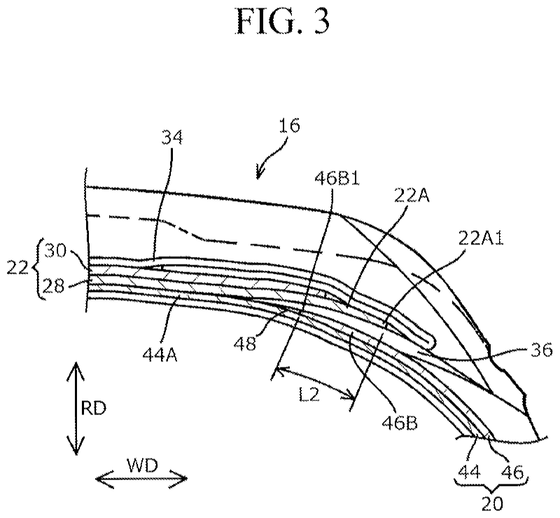

As illustrated in an enlarged manner in FIG. 3, a rubber-made belt under pad 36 is installed between an end portion 22A of the belt 22 (in detail, an end portion of the first belt 28) and the carcass ply 20.

On a tire outer surface side of the carcass ply 20 in the sidewall 14, sidewall rubber 37 is provided to constitute a tire outer surface.

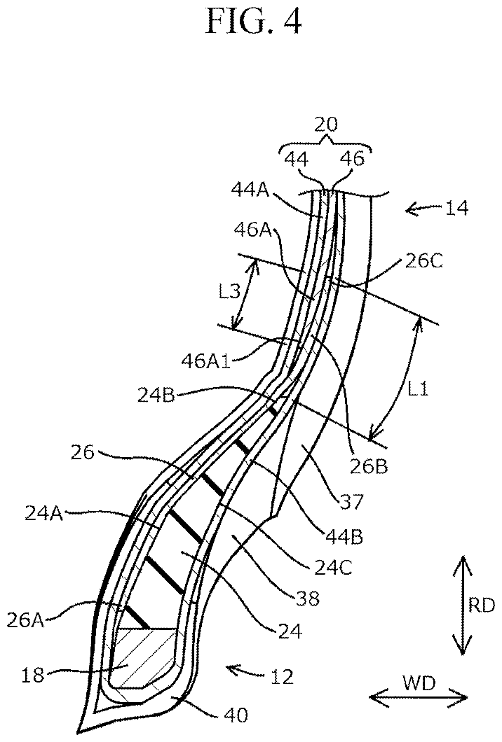

As illustrated in an enlarged manner in FIG. 4, in the bead 12, rim strip rubber 38 that serves as an outer surface of the bead 12 and comes into contact with the rim is provided next to the sidewall rubber 37. In addition, the bead 12 is provided with a rubber chafer 40 to cover the carcass ply 20 from the inner side in the tire radial direction RD.

On a tire inner surface of the tire 10, that is, on a tire inner surface side of the carcass ply 20, an inner liner 42 that is formed from air-impermeable rubber is provided.

The side reinforcement layer 26 is a reinforcement layer that includes the metal cords such as the steel cords. For example, similar to the belt 22, the side reinforcement layer 26 is formed by inclining the metal cords at the specified angle (for example, 15° to 35°) with respect to the tire circumferential direction, disposing the metal cords at specified intervals, and being covered with the topping rubber. In the embodiment, an angle of the metal cords in the side reinforcement layer 26 with respect to the tire circumferential direction is smaller than an angle of the organic fiber cords in the carcass ply 20 with respect to the tire circumferential direction.

As illustrated in FIG. 4, the side reinforcement layer 26 is arranged along a lateral surface of the bead filler 24. In detail, the side reinforcement layer 26 is superimposed on the lateral surface of the bead filler 24 and adheres to the lateral surface. In this example, the side reinforcement layer 26 is arranged along a lateral surface (that is, an inner lateral surface) 24A on the inner side in the tire width direction WD of the bead filler 24.

In this example, the side reinforcement layer 26 extends from a lower end of the bead filler 24 to the outer side in the tire radial direction RD, and is superimposed on the entire inner lateral surface 24A of the bead filler 24. An inner end 26A in the tire radial direction RD of the side reinforcement layer 26 is located near the lower end of the bead filler 24, and is located on the outer side in the tire radial direction RD of the bead core 18 so as not to be superimposed on the bead core 18. The side reinforcement layer 26 does not always have to be provided for the entire inner lateral surface 24A. For example, the side reinforcement layer 26 may extend to the outer side in the tire radial direction RD from an intermediate position in a height direction of the inner lateral surface 24A.

The side reinforcement layer 26 extends to the outer side in the tire radial direction RD beyond an outer-side end 24B in the tire radial direction RD of the bead filler 24 (that is, an outer end of the bead filler 24). A length L1 of an extending section 26B that extends beyond this outer end 248 is preferably equal to or longer than 10 mm. In order to prevent a crack, an outer end 26C in the tire radial direction RD of the side reinforcement layer 26, that is, a tip of the extending section 268 is located on the inner side in the tire radial direction RD of a tire maximum width position P1 (see FIG. 1). The extending section 26B of the side reinforcement layer 26 is an outer end portion in the tire radial direction RD of the side reinforcement layer 26.

Here, the tire maximum width position P1 is a position at which a profile line of an outer surface of the tire 10 in the sidewall 14 is the farthest from the tire equatorial plane CL in the tire width direction WD, and is a position in the tire radial direction RD of such a tire. The profile line is a contour of an outer surface of a side wall body excluding a projection such as a rim protector and usually has a tire meridian cross-sectional shape that is defined by smoothly connecting plural arcs.

In this embodiment, the carcass ply 20 is constructed of: a first ply 44 stretched between the paired bead cores 18; and a second ply 46 arranged on the tire outer surface side of the first ply 44 (for example, on the outer side in the tire width direction WD in the sidewall 14).

The first ply 44 includes: a toroidal ply body 44A that continues between the paired bead cores 18; and a folded section 44B that extends from the ply body 44A and is folded around the bead core 18 from the inner side in the tire width direction WD to the outer side therein. Accordingly, the first ply 44 is locked by folding both end portions thereof. For this reason, the bead core 18 and the bead filler 24 are disposed between the ply body 44A and the folded section 44B.

The ply body 44A is stretched from the tread 16 to the bead 12 through the sidewall 14 on each of the sides, extends along the inner lateral surface 24A of the bead filler 24 in the bead 12, and further extends to an inner circumferential surface of the bead core 18. The ply body 44A extends on the tire inner surface side of the side reinforcement layer 26.

The folded section 44B extends from the inner circumferential surface of the bead core 18 to the outer side in the tire radial direction RD along a lateral surface (that is, an outer lateral surface) 24C on the outer side in the tire width direction WD of the bead filler 24. In this example, the folded section 44B extends beyond the outer end 24B of the bead filler 24, further extends beyond the outer end 26C of the side reinforcement layer 26, and extends beyond the tire maximum width position P1. Thus, an outer end 44B1 in the tire radial direction RD of the folded section 44B is located on the outer side in the tire radial direction RD of the tire maximum width position P1. Here, a position of the outer end 44B1 of the folded section 44B is not particularly limited and may be located on the inner side in the tire radial direction RD of the tire maximum width position P1, for example.

The second ply 46 is a ply with a blank structure that has a missing section 48 in the crown, that is, the top portion of the toroidal carcass ply 20, and is also referred to as a blank ply. That is, the crown is excluded from the second ply 46, and the second ply 46 includes a right and left pair of plies, each of which extends from each end portion of the tread 16 to the sidewall 14 on the respective side.

One end of the second ply 46, in detail, one end of each of the paired plies constituting the second ply 46 is superimposed on the end portion 22A of the belt 22, and the other end thereof is superimposed on the side reinforcement layer 26 without being folded around the bead core 18. That is, an inner end portion 46A in the tire radial direction RD of the second ply 46 is superimposed on the extending section 26B that is the outer end portion in the tire radial direction RD of the side reinforcement layer 26. Then, the second ply 46 extends to the outer side in the tire radial direction RD from the inner end portion 46A and is terminated at a position at which the second ply 46 is superimposed on the end portion 22A of the belt 22.

In detail, as illustrated in FIG. 2 and FIG. 3, an outer end portion 46B in the tire radial direction RD of the second ply 46 is superimposed on the end portion 22A in the tire width direction WD of the belt 22. In this example, the outer end portion 46B of the second ply 46 is superimposed on the end portion in the tire width direction WD of the first belt 28 via the belt under pad 36. In this example, the outer end portion 46B of the second ply 46 is held and locked between the ply body 44A of the first ply 44 and the end portion 22A of the belt 22.

An outer end (that is, a tip of the outer end portion 46B) 46B1 in the tire radial direction RD of the second ply 46 is located on the inner side in the tire width direction WD of a width-direction outer end 22A1 of the belt 22 and is terminated at a position at which the outer end 46B1 is superimposed on the end portion 22A of the belt 22. Here, the position to be superimposed on the end portion 22A of the belt 22 corresponds to 15%, further preferably, 10% of an entire width in the tire width direction WD of the belt 22 from the width-direction outer end 22A1 of the belt 22. A superimposition width L2 between the second ply 46 and the belt 22 is not particularly limited. In an embodiment, the superimposition width L2 is preferably equal to or longer than 5 mm as a length along the second ply 46 (in detail, a length that is obtained by drawing a normal line from the width-direction outer end 22A1 of the belt 22 to the second ply 46 and is along the second ply 46 from a point of intersection of the normal line with the second ply 46 to the outer end 46B1), and is further preferably 5 to 20 mm in consideration of processing.

As illustrated in FIG. 2 and FIG. 4, the inner end portion 46A in the tire radial direction RD of the second ply 46 is superimposed on the extending section 26B of the side reinforcement layer 26. In this example, the inner end portion 46A of the second ply 46 is arranged between the ply body 44A of the first ply 44 and the extending section 26B of the side reinforcement layer 26. In this way, the inner end portion 46A of the second ply 46 is held and locked between the ply body 44A and the side reinforcement layer 26.

An inner end (that is, a tip of the inner end portion 46A) 46A1 in the tire radial direction RD of the second ply 46 is located on the inner side in the tire radial direction RD of the outer end 26C of the side reinforcement layer 26. The inner end 46A1 is located on the outer side in the tire radial direction RD of the outer end 24B of the bead filler 24. That is, the second ply 46 is terminated before reaching the outer end 24B of the bead filler 24 so as not to be superimposed on the bead filler 24. A superimposition width L3 between the second ply 46 and the side reinforcement layer is not particularly limited. In an embodiment, the superimposition width L3 is preferably equal to or longer than 5 mm as a length along the second ply 46, and is further preferably 5 to 20 mm in consideration of the processing.

In the pneumatic tire 10 according to this embodiment, the side reinforcement layer 26 is provided to extend beyond the outer end 24B of the bead filler 24, and the second ply 46 as the blank ply is arranged to be superimposed on the extending section 26B as the outer end portion of the side reinforcement layer 26 and the end portion 22A of the belt 22. In this way, one end of the second ply 46 is fixed and held between the belt 22 and the first ply 44, and the other end thereof is fixed and held between the side reinforcement layer 26 and the first ply 44. As a result, the second ply 46 can bear a high tensile force at the time of filling the pneumatic tire 10 with an internal pressure and thus can contribute to improved rigidity.

The extending section 26B is provided to the highly-rigid side reinforcement layer 26 including the metal cords, and a width (that is, a length from the inner end 46A1 to the outer end 46B1) of the second ply 46 is set to be small. In this way, it is possible to improve the rigidity that contributes to maneuvering stability and the like while reducing weight and to simultaneously obtain the rigidity and the weight reduction.

In this embodiment, the inner end portion 46A of the second ply 46 is arranged between the ply body 44A of the first ply 44 and the extending section 26B of the side reinforcement layer 26. In this way, the inner end portion 46A of the second ply 46 can further firmly locked.

In this embodiment, the side reinforcement layer 26 is arranged along the inner lateral surface 24A of the bead filler 24. In this way, it is possible to further enhance an effect of locking the inner end portion 46A of the second ply 46.

### Second Embodiment

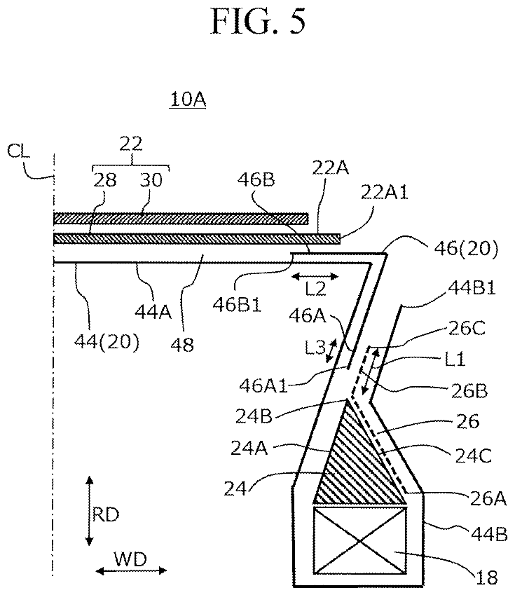

FIG. 5 is a schematic view of a half cross section of a pneumatic tire 10A according to a second embodiment, and FIG. 6 is a cross-sectional view of a part of the tire 10A. The second embodiment differs from the first embodiment in a point that the side reinforcement layer 26 is arranged along the lateral surface (that is, the outer lateral surface) 24C on the outer side in the tire width direction WD of the bead filler 24.

That is, in the second embodiment, the side reinforcement layer 26 is superimposed on the outer lateral surface 24C of the bead filler 24 and adheres to the outer lateral surface 24C. The side reinforcement layer 26 extends from the lower end of the bead filler 24 to the outer side in the tire radial direction RD along the outer lateral surface 24C, extends beyond the outer end 24B of the bead filler 24, and extends to the outer side in the tire radial direction RD. Similar to the first embodiment, the length L1 of the extending section 26B that extends beyond the outer end 24B is preferably equal to or longer than 10 mm. In addition, the outer end 26C of the side reinforcement layer 26 is located on the inner side in the tire radial direction RD of the tire maximum width position P1.

The configuration of the carcass ply 20 is the same as that in the first embodiment. However, since the side reinforcement layer 26 is arranged along the outer lateral surface 24C of the bead filler 24, the ply body 44A of the first ply 44 is directly superimposed on the inner lateral surface 24A of the bead filler 24. The folded section 44B extends to the outer side in the tire radial direction RD on the tire outer surface side of the side reinforcement layer 26, extends beyond the outer end 24B of the bead filler 24, and further extends beyond the outer end 26C of the side reinforcement layer 26.

Meanwhile, the second ply 46 as the blank ply is the same as that in the first embodiment. That is, the inner end portion 46A of the second ply 46 is superimposed on the extending section 26B of the side reinforcement layer 26, and the second ply 46 extends to the outer side in the tire radial direction RD from the inner end portion 46A and is terminated at a position at which the second ply 46 is superimposed on the end portion 22A of the belt 22. The inner end portion 46A of the second ply 46 is arranged and locked between the ply body 44A of the first ply 44 and the extending section 26B as the outer end portion of the side reinforcement layer 26.

In the second embodiment, similar to the first embodiment, the extending section 26B is provided to the side reinforcement layer 26, and the width of the second ply 46 is set to be small. Thus, it is possible to improve the rigidity while reducing the weight. In addition, the inner end portion 46A of the second ply 46 is arranged between the ply body 44A of the first ply 44 and the extending section 26B of the side reinforcement layer 26. Thus, it is possible to enhance a locking effect of the inner end portion 46A of the second ply 46.

The rest of the configuration and effects in the second embodiment are the same as those in the first embodiment, and thus the detailed description thereon will not be made.

### Third Embodiment

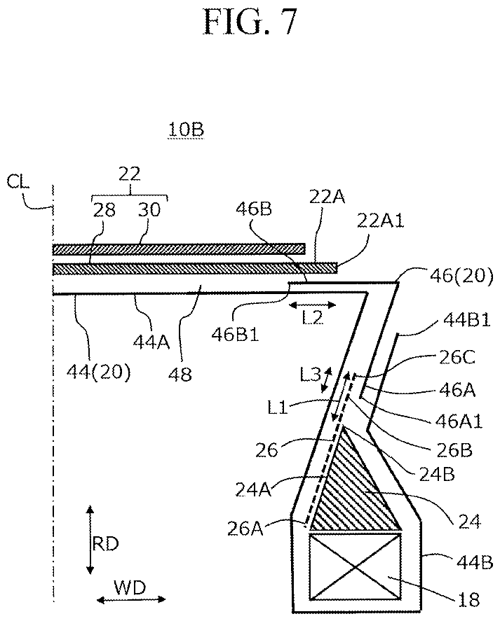

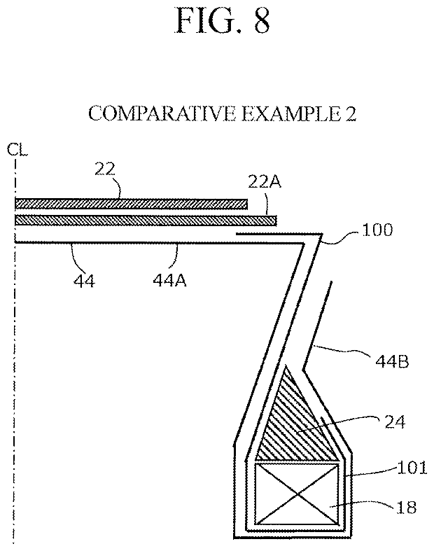

FIG. 7 is a schematic view of a half cross section of a pneumatic tire 10B according to a third embodiment. The third embodiment differs from the first embodiment in a point that the inner end portion 46A of the second ply 46 as the blank ply is arranged between the extending section 26B as the outer end portion of the side reinforcement layer 26 and the folded section 44B of the first ply 44.

That is, in the third embodiment, similar to the first embodiment, the side reinforcement layer 26 is arranged along the inner lateral surface 24A of the bead filler 24, extends beyond the outer end 24B of the bead filler 24, and extends to the outer side in the tire radial direction RD. In the carcass ply 20, the first ply 44 is the same as that in the first embodiment, and the configuration of the outer end portion 46B of the second ply 46 is also the same as that in the first embodiment.

Meanwhile, the inner end portion 46A of the second ply 46 differs from that in the first embodiment, is arranged on the outer side in the tire width direction WD of the extending section 26B of the side reinforcement layer 26, and is held and locked between the extending section 26B and the folded section 44B of the first ply 44. The inner end 46A1 of the second ply 46 is located on the inner side in the tire radial direction RD of the outer end 26C of the side reinforcement layer 26 and is located on the outer side in the tire radial direction RD of the outer end 24B of the bead filler 24. Similar to the first embodiment, the superimposition width L3 between the second ply 46 and the side reinforcement layer 26 is preferably equal to or longer than 5 mm, for example, 5 to 20 mm as the length along the second ply 46.

In the third embodiment, similar to the first embodiment, the extending section 26B is provided to the side reinforcement layer 26, and the width of the second ply 46 is reduced. Thus, it is possible to improve the rigidity while reducing the weight. The rest of the configuration and effects in the third embodiment are the same as those in the first embodiment, and thus the detailed description thereon will not be made.

[Others]

A dimension of each of the components, the tire maximum width position, and the like in this embodiment are values that are measured in an unloaded state where the pneumatic tire is attached to a legitimate rim and is filled with a legitimate inner pressure. In a system of standards including a standard with which the tire complies, the legitimate rim is a rim that is defined per tire in the standard. For example, the legitimate rim is specified as the “standard rim” in the JATMA standards, the “Design Rim” in the TRA standards, and the “Measuring Rim” in the ETRTO standards. In addition, in the system of the standards including the standard with which the tire complies, the legitimate inner pressure means a pneumatic pressure that is defined per tire in each of the standards, and is specified as the “Maximum inflation pressure” in the JATMA standards, a maximum value set in the “TIRE LOAD LIMITS AT VARIOUS COLD INFLATION PRESSURES” in the TRA standards, and the “INFLATION PRESSURE” in the ETRTO standards.

### EXAMPLE

A prototype of a pneumatic radial tire (size: 225/55R19 99V) in Example 1 was created according to the structures illustrated in FIG. 1 to FIG. 4. In the tire of Example 1, the steel cords of 2+2×0.25HT with an angle with respect to the tire circumferential direction being set at 23° were disposed to have end count of 20/25 mm and used as the side reinforcement layer 26. Then, the extending section 26B was set to have the length L1=15 mm. As the carcass ply 20, rubber-coated fabric was formed by disposing polyester cords of 1670 dtex/2 to be substantially orthogonal to the tire circumferential direction and have end count of 23/25 mm, and was used for the first ply 44 and the second ply 46. Then, a width of the second ply 46 was set to 85 mm. The outer end portion 46B of the second ply 46 and the end portion 22A of the belt 22 were superimposed to have the superimposition width L2=11 mm. The inner end portion 46A of the second ply 46 and the side reinforcement layer 26 were superimposed to have the superimposition width L3=9 mm.

As Comparative Example 1, a prototype of a pneumatic radial tire was created. In the pneumatic radial tire, the carcass ply 20 was constructed of two plies that did not have the missing section 48 (that is, not the blank plies), the side reinforcement layer 26 was not provided, and the rest of the configuration was the same as that in Example 1.

As Comparative Example 2, as illustrated in FIG. 8, a prototype of a pneumatic radial tire was created. In the pneumatic radial tire, the side reinforcement layer 26 was not provided in comparison with Example 1, a blank ply 100 with a conventional structure was arranged instead of the second ply 46, and the rest of the configuration was the same as that in Example 1. The blank ply 100 extends to the inner side in the tire radial direction from a position at which the blank ply 100 is superimposed on the end portion 22A of the belt 22, and has a folded section 101 that is folded around the bead core 18 from the inner side in the tire width direction to the outer side therein. Accordingly, one end of the blank ply 100 is locked by the belt 22 while the other end thereof is locked by the bead core 18.

The rigidity, cut resistance, and low rolling resistance performance of the tires in Example 1 and Comparative Examples 1, 2 were evaluated. Evaluation methods are as follows.
Rigidity (lateral rigidity): The legitimate rim (19×7.0) was attached to the prototype tire, the prototype tire was then filled with the internal pressure (250 kPa), a load (5.2 kN) was applied to the tire, and a lateral force was added to the tire at the same time. At the time, a magnitude of the lateral force that was required to bend the prototype tire in a lateral direction per unit length (1 mm) was measured. The measurement value was expressed as an index with the measurement value in Comparative Example 1 being set as 100. The higher index indicates higher lateral rigidity.
Cut resistance: The legitimate rim (19×7.0) was attached to the prototype tire, the prototype tire was then filled with the internal pressure (250 kPa), and the tire was pressed against a table provided with a triangular projection at a pressing velocity of 50±2.5 m/minute. Breaking energy was measured from the pressing force to the triangular table and a bending amount of the tire at the time when a side section of the tire contacted the rim and cord breaking sound is heard. The measurement value was expressed as an index with the measurement value in Comparative Example 1 being set as 100. The higher index indicates the superior cut resistance.
Low rolling resistance performance: The legitimate rim (19×7.0) was attached to the prototype tire, the prototype tire was then filled with the internal pressure (250 kPa), and the tire was made to travel under conditions of the load (5.2 kN) and a velocity (80 km/h) by using a rolling resistance measurement drum tester. Rolling resistance at the time was measured, and a reciprocal of the rolling resistance was expressed as an index with the measurement value in Comparative Example 1 being set as 100. The higher index indicates the superior low rolling resistance performance (that is, lower fuel consumption).

TABLE

| | Comparative | Comparative | First |
|---|---|---|---|
| | Example 1 | Example 2 | Embodiment |
| Carcass ply | Two-ply | FIG. 8 | FIG. 2 |
| configuration | configuration | | |
| | (without blank ply) | | |
| Side | None | None | Present |
| reinforcement | | | |
| layer | | | |
| Rigidity | 100 | 98 | 102 |
| Cut | 100 | 100 | 102 |
| resistance | | | |
| Low rolling | 100 | 103 | 105 |
| resistance | | | |
| performance | | | |

The results are as indicated in Table 1. Compared to Comparative Example 1 with the general two-ply configuration, in Comparative Example 2, the blank ply was used as the second ply, and as a result, an improving effect of the low rolling resistance performance by weight reduction could be obtained. However, the rigidity was degraded in Comparative Example 2. Meanwhile, in Example 1, the width of the second ply 46 was reduced to be smaller than that in Comparative Example 2. As a result, the weight was further reduced, which produced the superior improving effect of the low rolling resistance performance. In Example 1, the side reinforcement layer 26 was provided to extend to the outer side in the tire radial direction. As a result, the rigidity was improved, and the improving effect of the cut resistance of the sidewall was also obtained.

The several embodiments of the present invention have been described so far. These embodiments are merely provided as examples and thus have no intention to limit the scope of the invention. These embodiments can be implemented in any of various other aspects, and various types of elimination, replacement, and changes can be made thereto within the scope that does not depart from the gist of the invention. These embodiments and the modifications thereof are included in the scope and the gist of the invention and are also included in the invention described in the claims and the equivalent scope thereof.

What is claimed is:

1. A pneumatic tire comprising:
a pair of bead cores; a carcass ply that includes organic fiber cords and is stretched between the pair of bead cores; a belt that includes metal cords and is arranged on an outer side in a tire radial direction of a crown of the carcass ply; a bead filler that is arranged on an outer side in the tire radial direction of each of the bead cores; and a side reinforcement layer that includes metal cords, is arranged along a lateral surface of the bead filler, and extends to the outer side in the tire radial direction beyond an outer end of the bead filler, wherein
the carcass ply comprises: a first ply that is stretched between the pair of bead cores; and a second ply that is arranged on a tire outer surface side of the first ply, an inner end portion in the tire radial direction of the second ply being superimposed on an outer end portion in the tire radial direction of the side reinforcement layer, and the second ply extending to the outer side in the tire radial direction from the inner end portion and being terminated at a position at which the second ply is superimposed on an end portion of the belt.

2. The pneumatic tire according to claim 1, wherein
the first ply comprises: a ply body that continues between the pair of bead cores; and a folded section that extends from the ply body and is folded around the bead core from an inner side in a tire width direction to an outer side therein, and the inner end portion of the second ply is arranged between the ply body and the outer end portion of the side reinforcement layer.

3. The pneumatic tire according to claim 1, wherein
the first ply comprises: a ply body that continues between the pair of bead cores; and a folded section that extends from the ply body and is folded around the bead core from an inner side in a tire width direction to an outer side therein, and the inner end portion of the second ply is arranged between the folded section and the outer end portion of the side reinforcement layer.

4. The pneumatic tire according to claim 1, wherein
the side reinforcement layer is arranged along a lateral surface on an inner side in a tire width direction of the bead filler.

5. The pneumatic tire according to claim 1, wherein
the side reinforcement layer is arranged along a lateral surface on an outer side in a tire width direction of the bead filler.

6. The pneumatic tire according to claim 1, wherein
a tip of the inner, end portion of the second ply is located on the outer side in the tire radial direction of the outer end of the bead filler.

7. The pneumatic tire according to claim 1, wherein
a superimposition width between the second ply and the belt is 5 to 20 mm.

8. The pneumatic tire according to claim 1, wherein
a superimposition width between the second ply and the side reinforcement layer is 5 to 20 mm.

9. The pneumatic tire according to claim 1, wherein
a tip of the outer end portion of the side reinforcement layer is located on an inner side in the tire radial direction of a tire maximum width position.

10. The pneumatic tire according to claim 1, wherein
the first ply comprises: a ply body that continues between the pair of bead cores; and a folded section that extends from the ply body and is folded around the bead core from an inner side in a tire width direction to an outer side therein, and an outer end in the tire radial direction of the folded section is located on an outer side in the tire radial direction of a tire maximum width position.
